(19) United States
(12) Patent Application Publication
(10) Pub. No.: US 2005/0044480 A1
(43) Pub. Date: Feb. 24, 2005

(54) Process and system for the production of a multimedia edition on the basis of oral presentations

(76) Inventor: Jennifer Dahan Templier, Paris (FR)

Correspondence Address: YOUNG & THOMPSON, 745 SOUTH 23RD STREET, 2ND FLOOR, ARLINGTON, VA, 22202, US

(21) Appl. No.: 10/874,180

(22) Filed: Jun. 24, 2004

Related U.S. Application Data
(63) Continuation-in-part of application No. PCT/FR03/03952, filed on Dec. 31, 2003.

(30) Foreign Application Priority Data
Dec. 31, 2002 (FR) 02 16909

(51) Int. Cl. G06F 17/00

(52) U.S. Cl. 715/500.1

(57) ABSTRACT

Process for the production of a multimedia edition on the basis of oral presentations, from information contained in a previously recorded audio and/or video flow, and data and reference documents associated with the audio and/or video information. It includes both an indexing of the audio and/or video flow, in particular from the structure of the information contained, and an indexing of the supplementary data and reference documents. Heterogeneous data including information about the formal structure of an audio and/or video sequence contained in the audio and/or video flow, and data relating to reference documents associated with the audio and/or video sequence are stored chronologically in a common database. These heterogeneous data are then processed in a spreadsheet, along a time axis representing the passage of time in the time flow, and reworked in order to produce a complex indexing of the audio and/or video information and the supplementary data.

### CROSS REFERENCE TO RELATED APPLICATIONS

This is a continuation-in-part of international application PCT/FR03/03952 filed on Dec. 31, 2003, which designated the United States of America.

### BACKGROUND OF THE INVENTION

The present invention relates to a process for the production of a multimedia edition based on oral presentations. It also relates to a production system using this process, and to multimedia editions obtained on the basis of oral presentations by said production process.

By oral presentations is meant here any lectures or lessons, and any speeches and talks, recorded in video and/or audio form.

The need currently exists for a rapid production of multimedia environments around audio and/or video flows, with targeted access and synchronous additional information.

Non-limitatively there may be mentioned in particular the case of legal and scientific lectures and symposia which more and more often are the subject of audio and/or video recordings and of a distribution of a multimedia carrier containing both the talks given by the lecturers and documents related to these talks, which can be displayed simultaneously.

The audio and/or video flows resulting from these recordings generally correspond to discursive intelligence which is:
structured (with a complex plan structured in parts and sub-parts at different levels)
linked more or less directly with supplementary data, of varying nature, which it may be relevant to consult or to have available while listening to the audio and/or video flow.

These supplementary data are themselves more or less precisely located relative to a moment of the audio and/or video flow.

From the document US2002/0133520A1 a process is already known for preparing a multimedia recording of a presentation live comprising stages of collecting information associated with this presentation, recording the events of this presentation, digitizing any recording not digitally recorded, transferring these recordings to an electronic storage medium, and processing these recordings to create a digital multimedia presentation in which these events are presented in audio and visual formats which are automatically synchronized.

Moreover, processes currently exist for producing multimedia editions based on oral presentations which use procedures for access to several databases which consequently in particular result for the user in response times which can be a nuisance during consultation, and which necessitate a relatively costly development phase for each multimedia edition.

### SUMMARY OF THE INVENTION

The object of the present invention is to remedy these drawbacks and to propose a process for the production of a multimedia edition which compared with the existing production processes, gives users of multimedia products a greater flexibility, a greater ease of access to information and better processing time characteristics, while offering production costs which are significantly lower than those incurred by the existing processes.

This object is achieved with a process for the production of a multimedia edition based on oral presentations, starting on the one hand from information contained in a previously recorded audio and/or video flow and, on the other hand, from data and reference documents associated with said audio and/or video information, comprising both an indexing of the audio and/or video flow, in particular from its structure, and an indexing of said supplementary data and reference documents, so that said supplementary data and reference documents are consultable parallel to the audio and/or video flow on a display apparatus.

According to the invention, the process also includes the provision of a plurality of modes of presentation of the audio and/or video flow and/or of the associated data and reference documents, each mode of presentation resulting from a specific combination of the indexing of the audio and/or video flow and the indexing of the associated data and reference documents.

A user of a multimedia edition produced with the process according to the invention can thus select a particular presentation from several presentations. Moreover, the indexing principle used in the present invention is dual. There is indexing both of the audio and/or video flow, in particular from its structure and/or its plan, and of reference documents which are linked to this audio and/or video flow, these latter documents consultable in full, parallel to the video.

The plurality of modes of presentation can advantageously include a first mode called “Plan” corresponding to an indexing of only parts of the audio and/or video flow, a second mode called “Plan with documents” in which reference documents are chronologically incorporated according to the indexing of the audio and/or video flow, and a third mode called “Documents” in which the reference documents are displayed in a hierarchical and/or classified manner.

In another embodiment of the production process according to the invention, the plurality of modes of presentation includes a first consultation mode called “whole plan” containing links to all the reference documents or supplementary information associated with the audio and/or video flow.

When the reference documents associated with the audio and/or video flow are stored in a plurality of classes of reference documents, the plurality of modes of presentation then includes a plurality of other modes of consultation each associated with a class of reference documents, each other mode of consultation associated with a class of reference documents containing links to said reference documents contained in said class.

One class of reference documents can for example comprise audio and/or video sequences complementing the audio and/or video flow, which can be independent of the audio and/or video flow.

The information contained in the audio and/or video flow is preferably organised to create a targeted access and an indexing of audio and/or video sequences. The information contained in the previously recorded audio and/or video flow and the reference documents and associated data can advantageously be organized within an information structure centred on the reference documents so as to provide both (i) an access to relevant audio and/or video sequences via the indexing of the audio and/or video flow and (ii) an access to the reference documents via the indexing of these documents.

Thus, reference documents identified as being linked to the video are not just mentioned around the video. The information structure, which has the character of a matrix with on the one hand a time axis of the video and on the other hand several types of data, identified around the video is in fact completely transposed and as it were “inverted” to become an information structure centred on the reference documents, with a dual possibility of access to the relevant audio and/or video sequences (indexing of the audio and/or video flow), and to all of the reference documents (outline or complete text).

In a practical embodiment of the production process according to the invention, this can also include:
a chronological storage, in common database means, of heterogeneous data comprising information on the formal structure of an audio and/or video sequence contained in the audio and/or video flow, and data relating to reference documents associated with said audio and/or video sequence, and
a processing of said heterogeneous data in a spreadsheet, following a time axis which represents the passage of time in said time flow.

In the process according to the invention, the time axis of the spreadsheet sheet is thus operated on. This process, which closely interleaves information about the structure of the audio and/or video flow and associated supplementary data, permits in a simple way according to the needs of the processed material:
the supplementing/correction of the initial data from a single basic spreadsheet along the time axis of the audio and/or video flow,
the generation of an index and devices for accessing the audio and/or video fragments, which use supplementary data and allow consultation of the audio and/or video passages relating to this data,
the obtaining of classified, hierarchically ordered lists of supplementary data relating to this or that part of the audio and/or video flow,
the linking of any datum, even if it has not been specifically temporally coded over time, to a more or less precise time code by default, using the time codes of the structure/plan information which are in its proximity.

In a particular embodiment, the process according to the invention also comprises:
an acquisition of initial data relating to an audio and/or video sequence within an audio and/or video flow, in a standard spreadsheet format, with their structured description, these initial data containing time codes,
a supplementing of the initial data by information calculated so as to locate each of said data within the audio and/or video flow and the structure of said audio and/or video sequence,
a chronological storage, in a common database, of information about the formal structure of the audio and/or video sequence and supplementary data associated with said structural information, this complementary information and data comprising heterogeneous data,
a processing of said heterogeneous data in a spreadsheet, along a time axis which represents the passage of time in said time flow, and
sorting and retrieval operations carried out on the spreadsheet to generate a plurality of tables provided in order to allow a selective access to the contents of the audio and/or video flow.

The selective access tables are generated for example so as to procure access to the contents of the audio and/or video flow, which is structured by a predetermined data type.

The information intended to supplement the initial data can be calculated from an operation on the heterogeneous data chronologically ordered in the spreadsheet.

The calculated information associated with datum is preferably arranged so as to list associations with this datum all along the audio and/or video flow.

The production process according to the invention can also be arranged so as to procure a targeted access to the audio and/or video flow and to the information associated with this audio and/or video flow, by selection of a reference document from a table listing the reference documents associated with said audio and/or video flow.

Where the reference documents are stored in classes of reference documents, a targeted access to the audio and/or video flow and to the information associated with this audio and/or video flow can then be provided, by selecting a document from a table of reference documents belonging to one class of reference documents among a plurality of classes of reference documents.

According to another feature of the invention, a system is proposed for the production of a multimedia edition from, on the one hand, information contained in a previously recorded audio and/or video flow, and on the other hand from data and reference documents associated with said audio and/or video information, putting the invention into practice, comprising means for indexing the audio and/or video flow, in particular from its structure, and means for indexing said supplementary data and reference documents, so that said supplementary data and reference documents are consultable parallel to the audio and/or video flow on a display apparatus, characterized in that it is arranged to provide a plurality of modes of presentation of the audio and/or video flow and/or of the data or associated supplementary information and reference documents, each mode of presentation resulting from a specific combination of the indexing of the audio and/or video flow and of the indexing of the supplementary associated data or information and reference documents.

The production system according to the invention can also advantageously comprise:
means for acquiring initial data relating to an audio and/or video sequence within an audio and/or video flow, in a standard spreadsheet format, with their structured description, these initial data having time codes,
means for supplementing initial data by information calculated so as to locate each of said data within the audio and/or video flow and the structure of said audio and/or video sequence,
means for storing chronologically, in a common database, information about the formal structure of the audio and/or video sequence and supplementary data associated with said structural information, this supplementary information and data comprising heterogeneous data,
means for processing said heterogeneous data in a spreadsheet, along a time axis which represents the passage of time in said time flow, and
means for generating, by sorting and retrieval operations carried out on the spreadsheet, a plurality of tables provided in order to allow selective access to the contents of the audio and/or video flow.

### BRIEF DESCRIPTION OF THE DRAWINGS

Other advantages and features of the invention will become apparent upon examination of the detailed description of an embodiment which is in no way limitative, and of the attached drawings in which:

FIG. 1 illustrates several types of information entered into the database, for the putting into practice of the process according to the invention;

FIG. 2 illustrates an obtaining of supplementary time-based information from the database of heterogeneous data using the “vertical” axis of the spreadsheet;

FIG. 3 illustrates a reworking of the initial database to allow targeted access to the audio and/or video flow according to a certain type of data;

FIG. 4 represents an example of the structure of a system for producing a multimedia edition according to the invention;

FIGS. 5 to 7 represent graphics user interfaces of a first example of multimedia product obtained with the process according to the invention, and corresponding respectively to three separate modes of presentation;

FIGS. 8 to 10 represent graphics interfaces of a second example of multimedia product obtained with the process according to the invention; and

FIGS. 11 to 13 illustrate an implementation of the process according to the invention in a law training session.

### DETAILED DESCRIPTION OF THE INVENTION

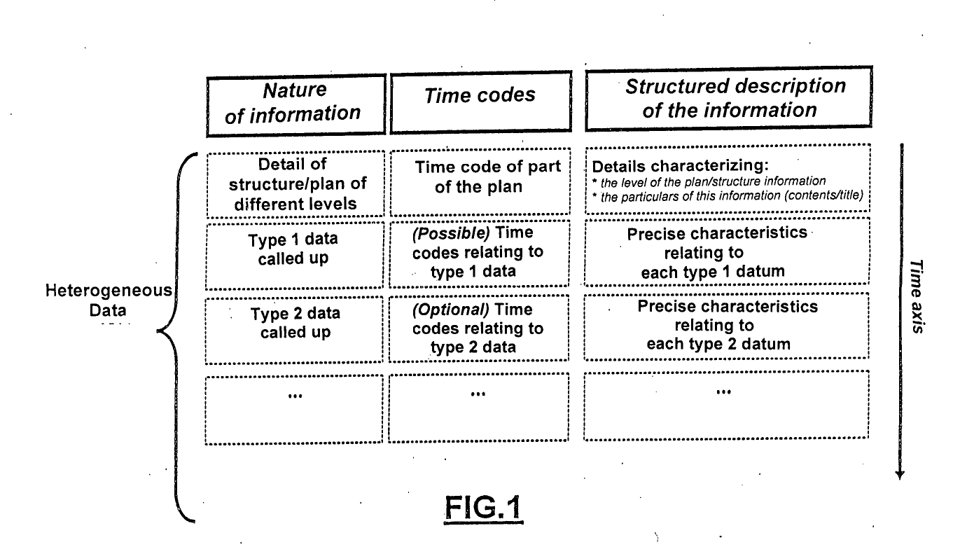

Firstly, the mechanism for processing heterogeneous data put into practice in the process according to the invention will be described. The initial data are read in or acquired in a standard spreadsheet format, with their structured description, with reference to FIG. 1. The time codes are central and generic data, but are not essential for all the data.

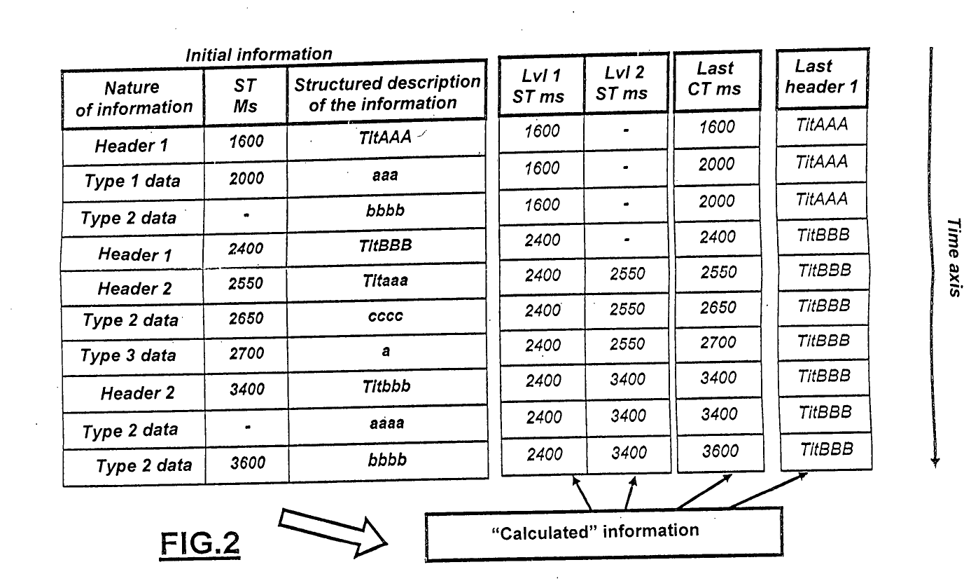

The initial data are supplemented by calculated information, with reference to FIG. 2, which locates each datum within the audio and/or video flow and its identified structure.

The calculated information, in particular a temporal marking of the data, is deduced from the working of heterogeneous data, ordered in time, which is constituted by the vertical axis of the spreadsheet.

This working is made possible in a simple way by analyzing step by step the information along the time axis for all this data (even though heterogeneous). The information “descends” or “climbs” following the time axis.

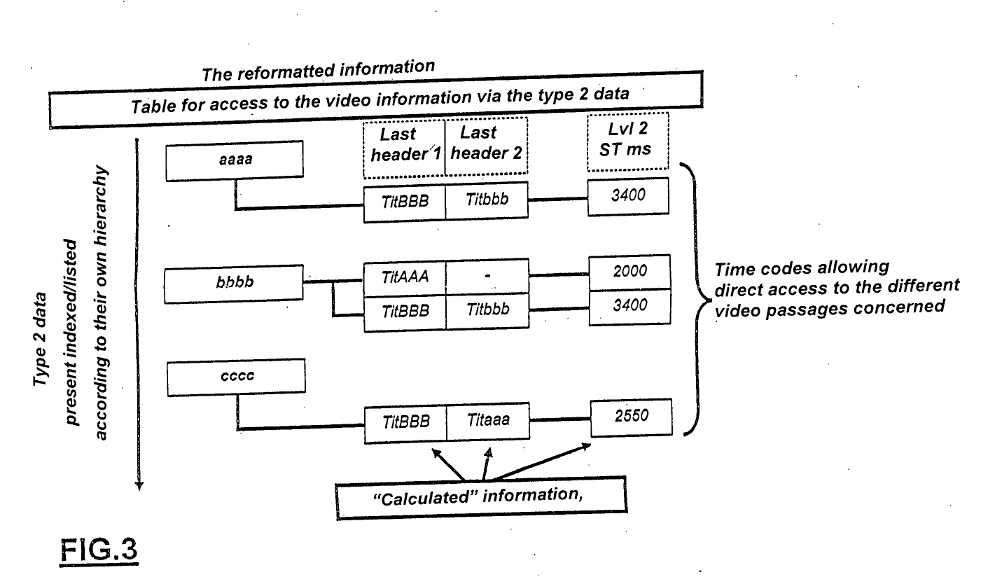

Simple sorting and retrieval operations on the thus-complemented spreadsheet allow tables to be produced allowing a targeted access, structured by this or that type of data, to the audio and/or video material, as the example of FIG. 3 illustrates.

The calculated information, which the structure of the spreadsheet has allowed to be associated with each datum, allows listing of any association with this datum all along the audio and/or video flow, locating it in the latter and directly accessing it, giving priority to the suited time code level.

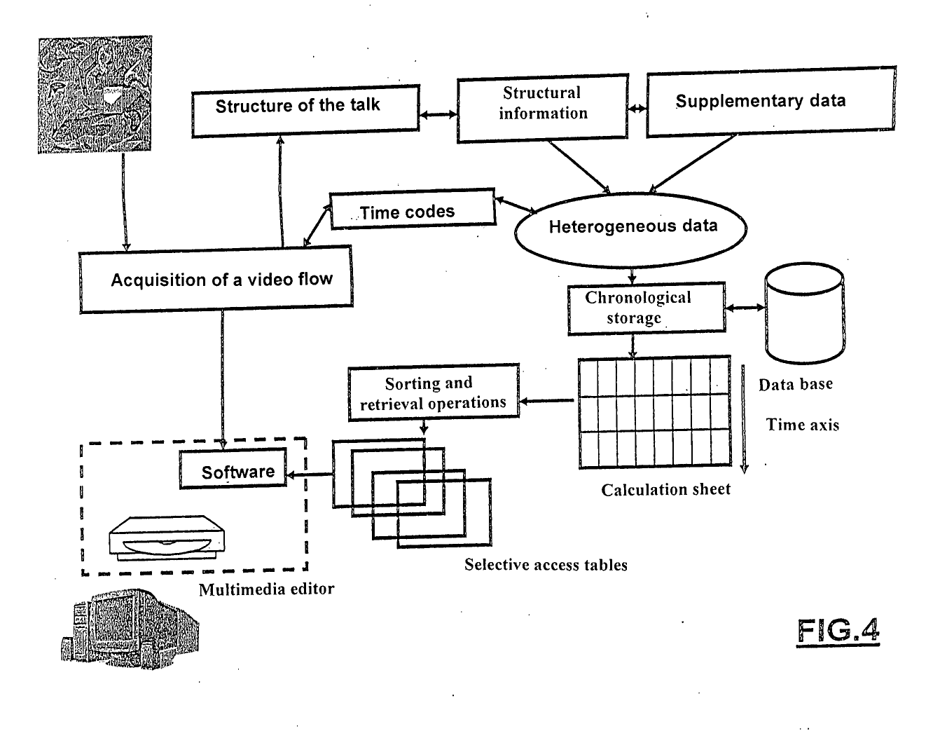

With reference to FIG. 4, an embodiment of a system for production of a multimedia edition according to the invention will now be described. A lecture is firstly recorded in the form of an oral flow (video and/or audio). This is an audiovisual production activity (recording, assembly).

Associated with this lecture is the structure of a talk, for example the plan of this talk, described by structural information with which are associated supplementary data such as references to publications or articles cited by the lecturer. This may equally involve definitions of words or concepts used in the main oral flow, or even multimedia links with audio and/or video sequences supplementing the main oral flow, constituting a deeper examination of the latter, while remaining independent of it.

The set of structural information and supplementary data, which constitutes heterogeneous data, is listed chronologically in a spreadsheet. This is a “craft” structuring and inputting production stage.

The heterogeneous data are processed, using commodity or specifically developed spreadsheet software, in a spreadsheet. Sorting and retrieval operations carried out on specific data from the set of heterogeneous data allow the generation, from the spreadsheet, of a set of tables for selective access designed to allow targeted access to selected fragments of the sequence concerned within the audio and/or video flow. This process of generating selective access tables can be automated.

The multimedia edition produced with the system according to the invention consists of the combination of an audio and/or video flow digitally recorded on a carrier such as a CD-ROM or any other digital carrier, the set of selective access tables from the spreadsheet, and software for working on these tables.

The user of a multimedia edition obtained with the production process according to the invention has an interactive tool which allows him to have, on a single frame, a first window broadcasting an audio and/or video flow and a second window for displaying data and information relating to the video sequence being broadcast. Numerous modes of access can then be envisaged in order to fully exploit the advantages obtained by the organisation process according to the invention. Very many functionalities can then be proposed such as real-time tracking of the lecture plan or real-time access to bibliographical references relating to the lecturer's talk.

With reference to FIGS. 5 to 7, examples of frames will now be described, in the form of graphics user interfaces, of a multimedia product obtained with the production process according to the invention from a legal lecture, at the same time as functionalities obtained for the user of this multimedia product.

A user of a multimedia product obtained with the process according to the invention can access, with reference to FIG. 1, a frame 1, comprising a set 2 of toolbars and commands, a first window 3 displaying a video sequence, equipped with the usual video command functions (pause, fast forward or rewind, sound adjustment and counter), and a second window 4 simultaneously displaying a reference document.

The toolbars and command bars consist of a first bar 21 for accessing each of the contributions available in the multimedia product, for example in the form of photographic icons of each of the contributors, and a second bar 22 containing various access possibilities offered to a user of the multimedia product:
access by contributors,
access by regulation,
access by jurisprudence,
complete sources,
bibliography.

The document display window 4 is equipped in its upper part with a first tab 41 “Plan”, a second tab 42 “Plan with reference”, and a third tab 43 “References cited”.

In the particular case of FIG. 5, it is the “Plan” tab which has been activated and the user thus sees the plan of the lecturer's talk scroll at the same time as the video sequence plays. In this Plan mode, a user can be at any moment in the course of the lecturer's talk and in particular his line of argument. He can also navigate within the lecture or contribution, by clicking on plan elements in the documents display window. It should be noted that the overall structure of the lecture or of the contribution is always visible.

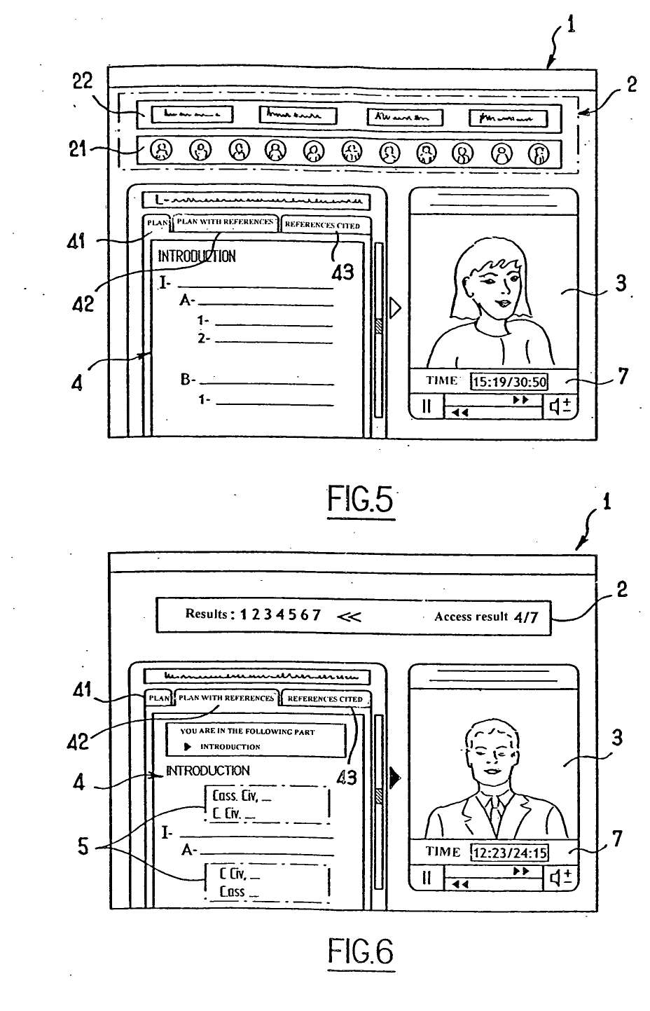

In the “Plan with references” display mode illustrated by FIG. 6, the user can display legal references 5, incorporated in the contributor's plan. In this mode it is still possible to access a precise video passage by clicking on a subdivision of the plan, or to access the complete text of legal, jurisprudence and regulatory references.

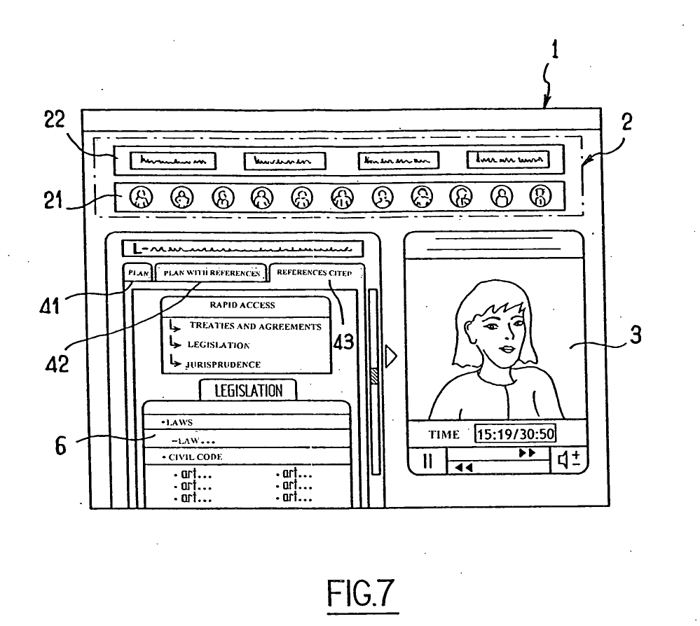

In the “References cited” display mode illustrated by FIG. 7, the set of legal references of a contributor are grouped and classified according to a hierarchy of the standards relating to the content of this multimedia edition. A user can thus refer to textual legal data 6 linked to the contribution, and with a simple click on a reference can access the complete text of this reference.

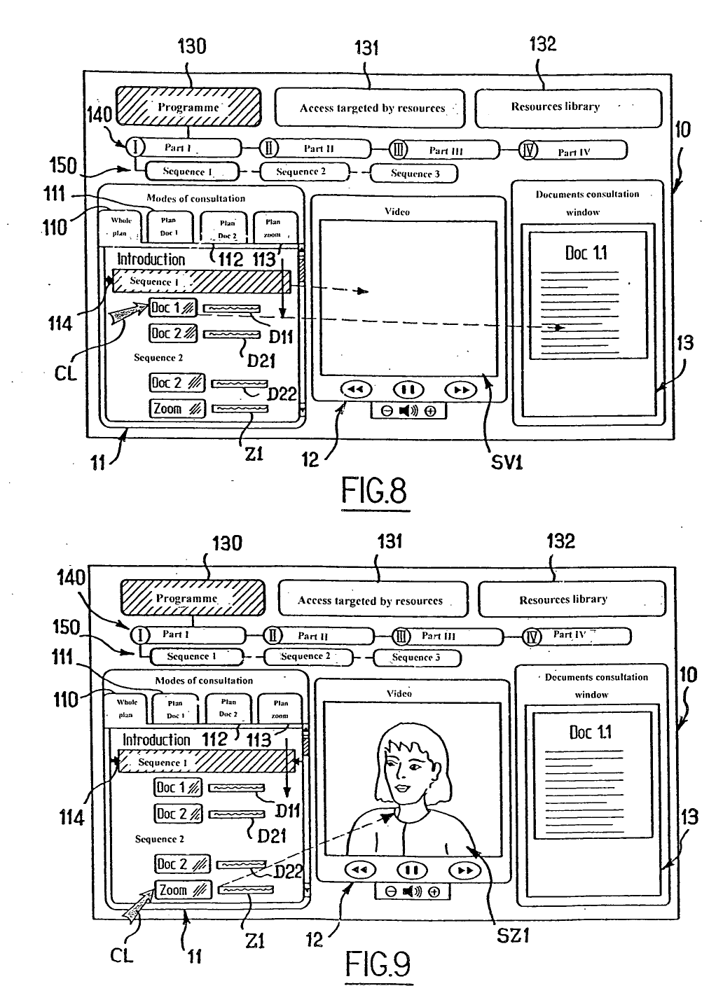

With reference to FIGS. 8 to 10, a second embodiment of a multimedia product obtained with a production process according to the invention will now be described.

A first graphics user interface 10 associated with this embodiment comprises, with reference to FIGS. 8 and 9:
three function-selection icons 130, 131, 132: “Programme”, “Access targeted by resources”, “Resources library”,
a display 140 of the different parts I, II, III, IV of an oral presentation,
a display 150 of a series of sequences of a part I of the oral presentation
a first window 11 displaying modes of consultation,
a second window 12 displaying video sequences, and
a third window 13 for consulting reference documents.

The display window 11 has in its upper part several tabs for selecting consultation modes:
a first consultation mode “complete plan” 110 allowing the display of the list of video sequences and the set of reference documents and supplementary information associated with these video sequences,
a second consultation mode “plan with Doc 1” 111 allowing the display of the list of video sequences and of only reference documents belonging to a first class of reference documents,
a third consultation mode “plan with Doc 2” 112 allowing the display of the list of video sequences and of only reference documents belonging to a second class of reference documents, and
a fourth consultation mode “plan with zoom” 113 allowing the display of the list of video sequences and of only documents of greater depth belonging to a class of documents called “Depth zoom” of video sequences.

By way of non-limitative example, within the framework of a multimedia product from an oral presentation in the legal field, the first class of reference documents can correspond to “words” of the Law, while the second class of reference documents can correspond to “clauses” of the Law.

When tab 110 “Whole plan” has been selected, the first window displays the whole plan of the presentation including for example a sequence 1 within which a reference document D11 belonging to the first class of documents and a reference document D21 belonging to the second class of documents are associated, and a sequence 2 within which a reference document D22 belonging to the second class of documents and a zoom document Z1 are associated.

When the video flow is temporal, a curser 114 points to the sequence 1 being displayed SV1 in video window 12. If the user selects by pointing at and clicking CL on the “Doc 1” icon corresponding to reference document D11, then the contents of the selected reference document appear in the consultation window 13.

If the user selects and clicks on the “Zoom” icon present in sequence 2 as illustrated by FIG. 9, a supplementary video sequence SZ1 corresponding to a further development of a particular point in the video sequence 2 then appears in video window 12.

It should be noted that arrangements of the tabs can be provided other than that illustrated in FIGS. 8 and 9. In particular, a “whole plan” tab which includes many “plan with documents” sub-tabs can be provided.

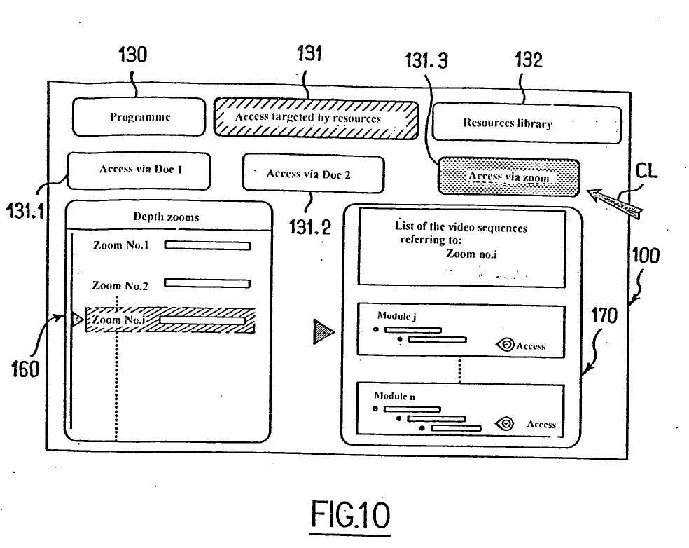

A second graphics user interface 100 of the multimedia product realized with the process according to the invention corresponds to selection of function 131 “Access targeted by resources”, with reference to FIG. 10. This selection brings about a display of several modes of access:
a mode 131.1 for access by reference documents belonging to the first class of reference documents, for example documents associated with “words” from the Law,
a mode 131.2 for access by reference documents belonging to the second class of reference documents, for example documents related to “clauses” of the Law, and
a mode 131.3 for access by “zoom” documents.

If a user selects and clicks on CL on icon 131.3 “Access by zoom”, there then appears in a first window 160 a list of the depth zooms present in the multimedia product: Zoom no. 1, Zoom no. 2, . . . , Zoom no. i, . . .

Selection of a particular zoom no. i within this list leads to a display in a second window 170 of a list of video sequences referring to this zoom no. 1, for example a video sequence included in a module j with the access path to this sequence, and another video sequence included in a module n with the corresponding access path. An action of the user on an “Access” icon of one of its modules results in direct access to the video flow at the selected module.

Classes of reference documents other than those which have just been described can be envisaged within the framework of the present invention. For example a “plan with bibliography” can be provided in which the reference documents are comprised of bibliographical references, as well as a “questions-answers plan” in which the reference documents are comprised of “question-answer” sequences.

To each of these classes of reference documents can correspond a mode of access specific to the content of the audio and/or video flow by reference documents belonging to this class. Thus a mode of access by bibliographical reference and a mode of access by “question-response” sequence can be provided.

The production process according to the invention can advantageously be used in the fields of legal, scientific and in particular medical lectures, as well as in the field of medical information. Electronic or “e-learning” training or teaching applications can also be provided. As well as its individual use, application in a group framework (for example video projection) is possible.

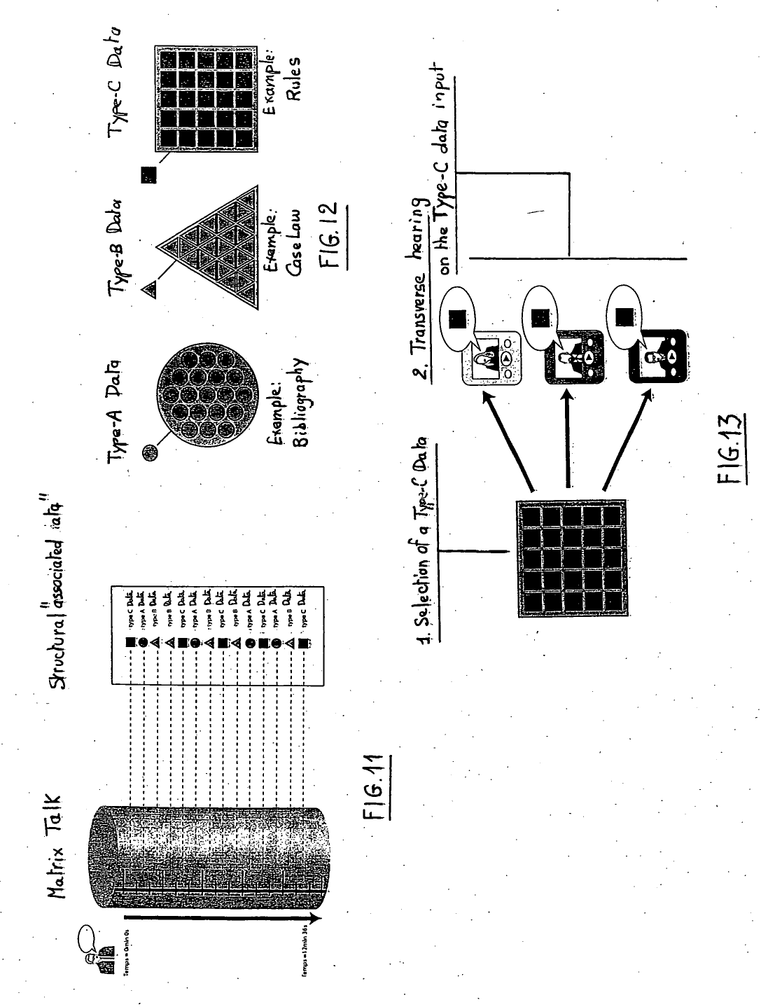

Therefore, as illustrated in FIGS. 11 to 13, the production process according to the invention can be implemented for a training session in law, wherein associated data, that are structurally inherent to the training session, can be arranged in three types of data:
Type-A Data, corresponding for example to Bibliography,
Type-B Data, corresponding for example to Case Law,
Type-C Data, corresponding for example to Rules.

A Matrix Talk for a training session is associated with associated data from any one of above-mentioned types. Said associated data are structural or structurally inherent to the field of the training session

In use of a multimedia edition obtained by the production process according to the invention, with reference to FIG. 13, a selection 1 of data with a determined type, for example type-C data (Rules), results in a possible transverse hearing 2 of presentation portions referring to type-C associated data.

Moreover, in the production process according to the invention, a talk or speech can be chaptered and indexed in such a way that, while the different lines of the talk's plan are successively scrolled within a plan display, video sequences within said talk are simultaneously displayed with exact correspondences to the contents of said scrolled lines. Furthermore, documents associated with a specific oral mention within the talk can be simultaneously displayed during the corresponding video sequence wherein said oral mention is done.

A multimedia edition obtained by a production process according to the invention can also be provided with a category or type-search tool within a talk or speech. For example, from a selection of an item (for example, a reference of a Rule) within an index of Rules, a software engine searches within a set of talks or speeches processed with the process according to the invention, in order to deliver video sequences wherein said searched item is present, either within the talk's plan and/or within the corresponding video sequence.

The invention is of course not limited to the examples which have just been described and numerous modifications can be made to these examples without going beyond the framework of the invention.

1. Process for the production of a multimedia edition on the basis of oral presentations, starting, on the one hand, from information contained in a previously recorded audio and/or video flow and, on the other hand, supplementary data or information and reference documents associated with said audio and/or video information, comprising both an indexing of the audio and/or video flow, in particular from its structure, and an indexing of said supplementary data or information and reference documents, so that said supplementary data and reference documents are consultable parallel to the audio and/or video flow on a display apparatus, characterized in that it also includes provision of a plurality of modes of presentation of the audio and/or video flow and/or of the associated supplementary data or information and reference documents, each mode of presentation resulting from a specific combination of the indexing of the audio and/or video flow and of the indexing of the associated supplementary data or information and reference documents.

2. Process according to claim 1, characterized in that the plurality of modes of presentation includes a first mode called “Plan” corresponding to an indexing of only parts of the audio and/or video flow.

3. Process according to claim 1, characterized in that the plurality of modes of presentation includes a second mode called “Plan with documents” in which reference documents are integrated chronologically according to the indexing of the audio and/or video flow.

4. Process according to claim 1, characterized in that the plurality of modes of presentation includes a third mode called “Documents” in which the reference documents are displayed hierarchically and/or in a classified fashion.

5. Process according to claim 1, characterized in that the many modes of presentation includes a first mode of consultation called “whole plan” containing links to all the reference documents or supplementary information associated with the audio and/or video flow.

6. Process according to claim 5, in which the reference documents associated with the audio and/or video flow are stored in a plurality of classes of reference documents, characterized in that the plurality of modes of presentation includes a plurality of other modes of consultation each associated with one class of reference documents, each other mode of consultation related to a class of reference documents containing links to said reference documents contained in said class.

7. Process according to claim 6, characterized in that a class of reference documents includes audio and/or video sequences supplementing the audio and/or video flow.

8. Process according to claim 7, characterized in that the supplementary audio and/or video sequences are independent of the audio and/or video flow.

9. Process according to claim 1, characterized in that the information contained in the audio and/or video flow is organized to create a targeted access and an indexing of audio and/or video sequences.

10. Process according to claim 1, characterized in that the information contained in the previously recorded audio and/or video flow and the reference documents and associated data are organized within an information structure centred on the reference documents, so as to obtain both (i) an access to relevant audio and/or video sequences via the indexing of the audio and/or video flow and (ii) an access to the reference documents via the indexing of these documents.

11. Process according to claim 1, characterized in that it also comprises:
a chronological storage, in common database devices, of heterogeneous data comprising information on the formal structure of an audio and/or video sequence contained in the audio and/or video flow, and data relating to reference documents associated with said audio and/or video sequence, and
a processing of said heterogeneous data in a spreadsheet, along a time axis which represents the passage of time in said time flow.

12. Process according to claim 11, characterized in that it also comprises generation of index of means of access to fragments of the audio and/or video sequence, from supplementary data, so as to procure a consultation of audio and/or video passages associated with this supplementary data.

13. Process according to claim 11, characterized in that it also includes provision of hierarchically ordered and classified lists of supplementary data relating to specific parts of the audio and/or video flow.

14. Process according to claim 11, characterized in that it also comprises the allocation of a time code by default to any datum of the time flow not previously time coded.

15. Process according to claim 14, characterized in that the allocation of a time code by default to a datum not previously time coded is carried out using information time codes relating to the formal structure of the audio and/or video sequence, situated in the proximity of said not previously time-coded datum.

16. Process according to claim 1, characterized in that it also comprises:
an acquisition of initial data relating to an audio and/or video sequence within an audio and/or video flow, in a standard spreadsheet format, with their structured description, these initial data containing time codes,
a supplementing of the initial data by information calculated so as to locate each of said data within the audio and/or video flow and the structure of said audio and/or video sequence,
a chronological listing, in a common database, of information about the formal structure of the audio and/or video sequence and supplementary data associated with said structural information, this supplementary information and data comprising heterogeneous data,
a processing of said heterogeneous data in a spreadsheet, along a time axis which represents the passage of time in said time flow, and
sorting and retrieval operations carried out on the spreadsheet in order to generate a plurality of tables provided in order to allow a selective access to the contents of the audio and/or video flow.

17. Process according to claim 16, characterized in that the tables for selective access are generated so as to procure access to the contents of the audio and/or video flow, which is structured by a predetermined data type.

18. Process according to claim 16, characterized in that the information intended to supplement the initial data is calculated from an operation on the heterogeneous data chronologically ordered in the spreadsheet.

19. Process according to claim 16, characterized in that the calculated information associated with a datum is arranged so as to list associations with this datum all along the audio and/or video flow.

20. Process according to claim 6, characterized in that it is arranged so as to procure targeted access to the audio and/or video flow and to the information relating to this audio and/or video flow, by selection of a reference document from a table listing the reference documents associated with said audio and/or video flow.

21. Process according to claim 20, characterized in that it is arranged so as to procure targeted access to the audio and/or video flow and to the information associated with this audio and/or video flow, by selection of a document from a table of reference documents belonging to a class of reference documents among a plurality of classes of reference documents.

22. System for the production of a multimedia edition based on oral presentations, from, on the one hand, information contained in a previously recorded audio and/or video flow, and on the other hand from data and reference documents associated with said audio and/or video information, putting into practice the process according to any one of the preceding claims, comprising means for indexing the audio and/or video flow, in particular from its structure, and means for indexing said supplementary data and reference documents, in order that said complementary data and reference documents are consultable parallel to the audio and/or video flow on a display apparatus, characterized in that it is arranged so as to provide a plurality of modes of presentation of the audio and/or video flow and/or of the associated complementary data or information and reference documents, each mode of presentation resulting from a specific combination of the indexing of the audio and/or video flow and of the indexing of the associated complementary data or information and reference documents.

23. System according to claim 22, characterized in that it also comprises:
means for entering initial data relating to an audio and/or video sequence within an audio and/or video flow, in a standard spreadsheet format, with their structured description, this initial data containing time codes,
means for supplementing initial data with information calculated so as to locate each of said data within the audio and/or video flow and the structure of said audio and/or video sequence,
means for storing chronologically, in a common database, information about the formal structure of the audio and/or video sequence and supplementary data associated with said structural information, this supplementary information and data comprising heterogeneous data,
means for processing said heterogeneous data in a spreadsheet, along a time axis which represents the passing of time in said temporal flow, and
means for generating, by sorting and retrieval operations carried out on the spreadsheet, a plurality of tables provided in order to allow selective access to the contents of the audio and/or video flow.

24. A multimedia edition obtained on the basis of oral presentations, by a production process according to claim 1.
